(19) United States
(12) Patent Application Publication
(10) Pub. No.: US 2024/0317094 A1
(43) Pub. Date: Sep. 26, 2024

(54) DOCKING AND CHARGING SYSTEMS AND METHODS FOR AUTOMATIC SWIMMING POOL CLEANERS

(71) Applicant: ZODIAC POOL CARE EUROPE, Belberaud (FR)

(72) Inventors: Simon Duffaut, Castelginest (FR); Mehdi Chafik, Tournefeuille (FR); Arnaud Besnier, Beaupuy (FR); Louis Favie, Colomiers (FR)

(73) Assignee: ZODIAC POOL CARE EUROPE, Belberaud (FR)

(21) Appl. No.: 18/612,295

(22) Filed: Mar. 21, 2024

Related U.S. Application Data
(60) Provisional application No. 63/454,027, filed on Mar. 22, 2023.

(51) Int. Cl. B60L 53/37; B60L 53/126; B60L 53/38; E04H 4/16; H02J 50/00; H02J 50/10

(52) U.S. Cl. CPC B60L 53/37; B60L 53/126; B60L 53/38; E04H 4/1654; H02J 50/005; H02J 50/10; B60L 2200/32

(57) ABSTRACT

A docking station for a pool cleaner includes at least one inductive element for charging the pool cleaner. A docking station for a pool cleaner may include means for guiding the pool cleaner to the docking station using light-based communication. In certain embodiments, the docking station for a pool cleaner may include means for engaging and/or supporting the pool cleaner at a waterline of a swimming pool or spa. A docking station for a pool cleaner a may enclose a pool cleaner within a receiving area in certain embodiments.

### REFERENCE TO RELATED APPLICATION

This application claims the benefit of U.S. Provisional Patent Application ON. 63/454,027, filed on Mar. 22, 2023, and entitled DOCKING AND CHARGING SYSTEMS AND METHODS FOR AUTOMATIC SWIMMING POOL CLEANERS, the content of which is hereby incorporated by reference in its entirety.

### FIELD OF THE INVENTION

This invention relates to equipment principally for use in connection with water-containing vessels such as swimming pools and spas and more particularly, but not necessarily exclusively, to automatic swimming pool cleaners (“APCs”).

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

Some APCs may be supplied with power using cabling that connects to a power source outside of the swimming pool or spa. Other APCs may use an onboard power source, such as but not limited to a battery. Some onboard power sources may be recharged or charged during a cleaning operation and/or when the APC is not in use by positioning the APC at a docking station. However, traditional docking stations require exposed electrical connectors such that the APC and/or power source is charged by physical connections (e.g., metal contact). Water from swimming pools or spas may cause corrosion and/or other damage to such exposed connectors.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to various embodiments, a fixed docking station for a pool cleaner may include at least one inductive element for contactless charging of the pool cleaner.

According to certain embodiments, a docking station for a pool cleaner may be provided out of water of a swimming pool or spa. The docking station may include a platform extending upwards at a non-zero angle relative to a horizontal axis and at least one inductive element on the platform for charging the pool cleaner.

According to some embodiments, a docking station for a pool cleaner is positionable within water and on a floor of a swimming pool or spa. The docking station includes at least one inductive element for charging the pool cleaner and may guide the pool cleaner to the docking station using light-based communications.

According to various embodiments, a docking station for a pool cleaner includes at least one inductive element for charging the pool cleaner. The docking station may guide the pool cleaner to the docking station using light-based communications.

According to some embodiments, a docking station for a pool cleaner may include at least one inductive element for charging the pool cleaner and may engage the pool cleaner at a waterline of a swimming pool or spa.

According to some embodiments, a docking station may support a pool cleaner at a waterline of a swimming pool or spa and may include at least one inductive element for charging the pool cleaner.

According to certain embodiments, a docking station may support a pool cleaner and provide access to a filter of the pool cleaner at or above a waterline of a swimming pool or spa. The docking station may include at least one inductive element for charging the pool cleaner.

According to various embodiments, a docking station for a pool cleaner includes a housing defining a receiving area for housing the pool cleaner and at least one inductive element for charging the APC within the receiving area.

According to some embodiments, a docking station for a pool cleaner includes a housing for receiving and concealing the pool cleaner and at least one inductive charging element for charging the pool cleaner.

According to various embodiments, a docking station for a pool cleaner may enclose the pool cleaner within a receiving area.

According to some embodiments, a pool cleaner for a swimming pool or spa may include at least one inductive element.

According to certain embodiments, a pool cleaner includes one or more batteries, and the one or more batteries are chargeable or rechargeable via induction charging.

According to various embodiments, a method includes charging or recharging an onboard power source of a pool cleaner using a docking station.

According to certain embodiments, a method includes guiding a pool cleaner to a docking station using light-based communication and inductively charging the pool cleaner at the docking station.

According to various embodiments, a method includes receiving a pool cleaner at a docking station and enclosing the pool cleaner within a receiving area of the docking station.

According to certain embodiments, a docking station for a pool cleaner includes a plurality of inductive elements for charging the pool cleaner when the pool cleaner is in one or more configurations or positions relative to the docking station.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figure, in which use of like reference numerals is intended to illustrate like or analogous components.

FIGS. 1A-B illustrate a docking system for a pool cleaner according to embodiments.

FIGS. 2A-C illustrate a docking system for a pool cleaner according to embodiments.

FIGS. 3A-D illustrate a docking system for a pool cleaner according to embodiments.

FIGS. 4A-F illustrate a docking system for a pool cleaner according to embodiments.

FIGS. 5A-D illustrate a docking system for a pool cleaner according to embodiments.

FIGS. 6A-F illustrates a docking process using the docking system of FIGS. 5A-D according to embodiments.

FIG. 7 illustrates a pool cleaner according to embodiments.

FIG. 8 illustrates a docking system according to embodiments.

### DESCRIPTION OF THE INVENTION

Described herein are improved docking and charging systems and methods for APCs. In certain embodiments, the systems and methods described herein may allow for charging or recharging of an onboard power source for the APC without requiring physical contact, thereby limiting corrosion and/or other potential damage caused by water of the swimming pool or spa. The systems and methods described herein may allow for charging of the power source of the APC while underwater, at a waterline, and/or out of the water of the swimming pool or spa. In various embodiments, the systems and methods described herein provide induction (and contactless) charging of the power source for the APC. The systems and methods described herein provide induction charging while the power source is onboard the APC and/or to a power source removed from the APC.

Additionally, or alternatively, the systems and methods described herein provide docking stations that communicate with APCs using light-based communication or signals, including but not limited to light fidelity (LiFi) signals. Such docking stations may guide the APC to the docking stations based on the light-based communication and/or otherwise provide information to the APC that the APC may use to control itself.

Additionally, or alternatively, the systems and methods described herein may provide docking stations that conceal or hide the APC when the APC is not in use. Such docking stations optionally may be integrated into the pool or spa, although they need not be in other embodiments.

Various other benefits and advantages may be realized with the systems, devices, and methods provided herein, and the aforementioned advantages should not be considered limiting.

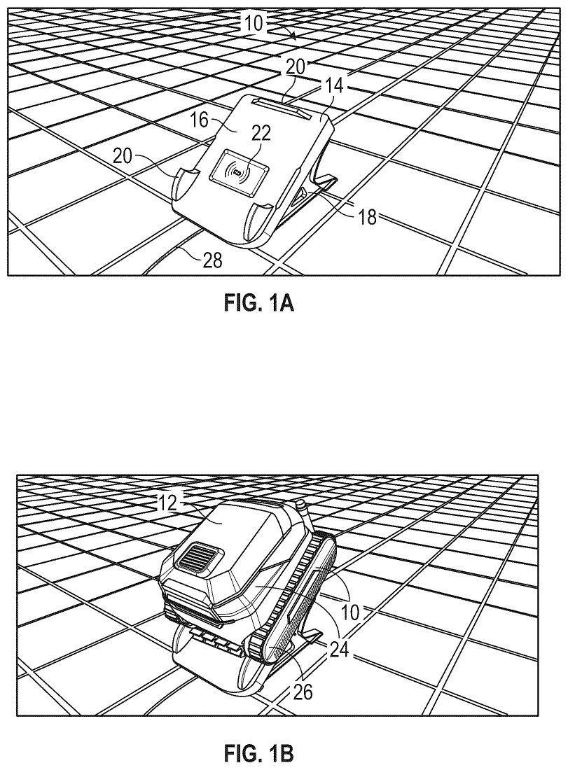

FIGS. 1A-B illustrate an example of a docking station 10 according to embodiments. In certain embodiments, the docking station 10 may selectively support the APC 12 at a location outside of water of a swimming pool or spa, such as but not limited to on a pool deck and/or other area relative to the swimming pool or spa as desired. The docking station 10 generally includes a platform 14 having a surface 16 for supporting the APC 12. One or more supports 20 may be provided for selectively supporting the APC 12 on the platform 14. The docking station 10 may include feet 18 such that the docking station 10 may be freestanding, although feet 18 need not be included in other embodiments. In certain embodiments and as illustrated, the platform 14 may extend at a non-zero angle (e.g., an oblique angle) relative to a surface on which the docking station 10 is positioned. In various embodiments, the platform 14 may extend at the non-zero angle relative to a horizontal axis. In certain embodiments, the docking station 10 optionally is a self-supporting docking station 10 such that the docking station 10 maintains its location once positioned and/or does not change its position unless moved by a user.

The docking station 10 may include a power source and/or may be connectable to a power source, e.g., using wiring or cabling 28. When the APC 12 is docked with the docking station 10, the docking station 10 may charge or recharge power sources of the APC 12. In certain embodiments, the APC 12 may be self-docking (e.g., a user and/or another device is not needed to dock the APC 12), although it need not be in other embodiments.

In various embodiments, the docking station 10 includes one or more inductive elements 22 for generating an electromagnetic field and wirelessly transferring electrical energy to the APC 12 as discussed in detail below. In some embodiments, the one or more inductive elements 22 may be integrated with the docking station 10 (e.g., are not removable absent destruction of the docking station 10) and/or may be connected to the docking station 10 using various techniques as desired. The number and location of inductive elements 22 on the docking station should not be considered limiting. In the example illustrated in FIGS. 1A-B, one inductive element 22 is on the platform 14.

The APC 12 generally includes a body 24 and one or more motive elements 26 (e.g., wheels, tracks, feet, etc.). A pump, filter assembly, cleaning device such as a brush assembly or other suitable device, any suitable electric or other motors, a controller (e.g., processor and memory), a communication module, and/or various other features may be provided on or within the APC 12 as desired. In some embodiments, the APC 12 may be a cordless APC 12, and/or the APC 12 may include an on-board power source (e.g., one or more rechargeable batteries). The APC 12 may be various types of APCs as desired, and the particular APC 12 illustrated should not be considered limiting. Other non-limiting examples of APCs 12 may include those described in U.S. Pat. Nos. 10,316,534, 9,488,154, 8,578,538, and U.S. Patent Publication No. 2014/0303810, all of which are hereby incorporated by reference in their entireties.

In certain embodiments, the APC 12 includes one or more inductive elements for receiving the transfer of electrical energy from the one or more inductive elements 22 of the docking station 10. As an example, when the APC 12 is positioned on the docking station 10 and/or otherwise at an electromagnetic field generated by the one or more inductive elements 22, energy may be wirelessly transferred from the one or more inductive elements 22 to the one or more inductive elements of the APC 12. The number and location of the one or more inductive elements on the APC 12 should not be considered limiting.

In certain embodiments, the docking station 10 and/or the APC 12 having a plurality of inductive elements may simplify and/or provide improved positioning of the APC 12 relative to the docking station 10 (e.g., the APC 12 may be in a plurality of configurations while still being able to charge). As non-limiting examples, the APC 12 may be capable of charging on the docking station 10 when the APC 12 is in a nominal forward (or parallel) orientation on the docking station 10, a nominal backward (or parallel) orientation on the docking station 10, a nominal side-to-side (or perpendicular) orientation on the docking station 10, a random orientation on the docking station 10, etc.

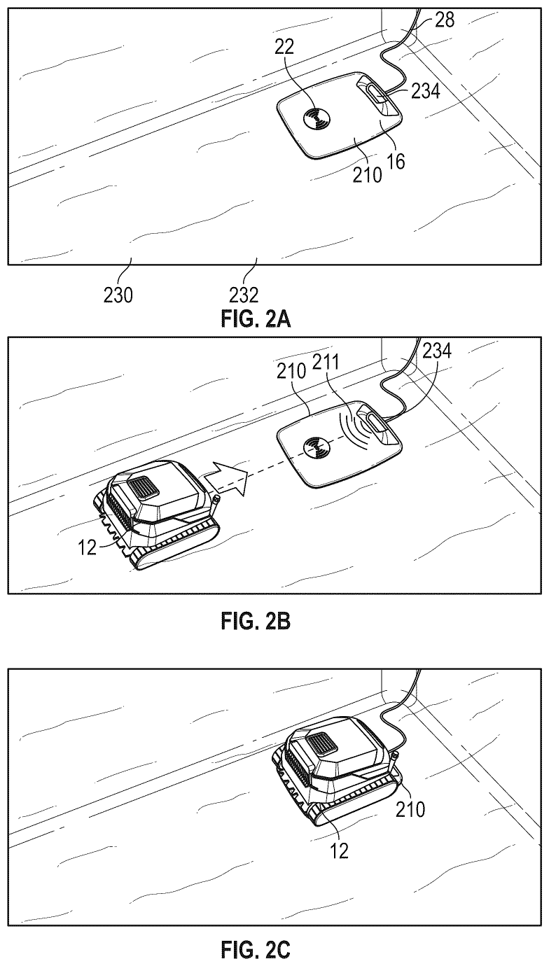

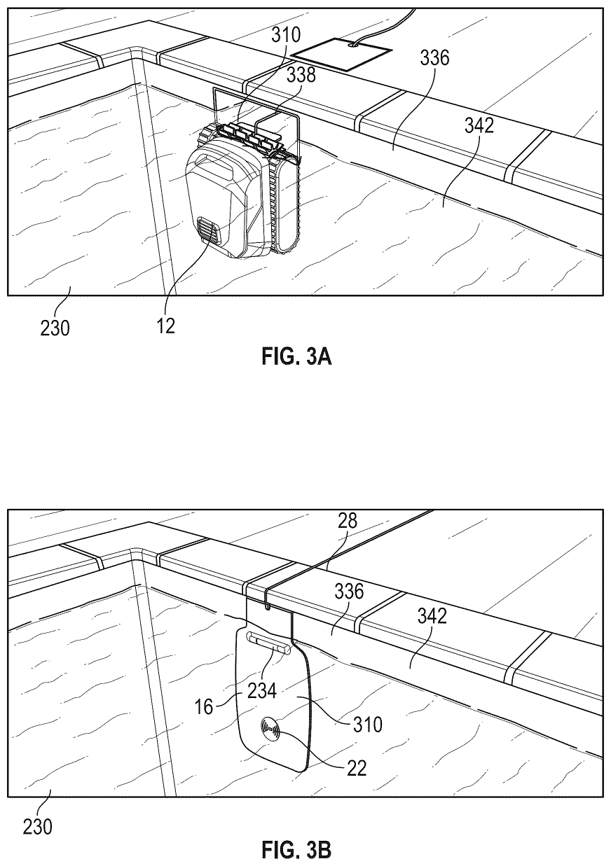

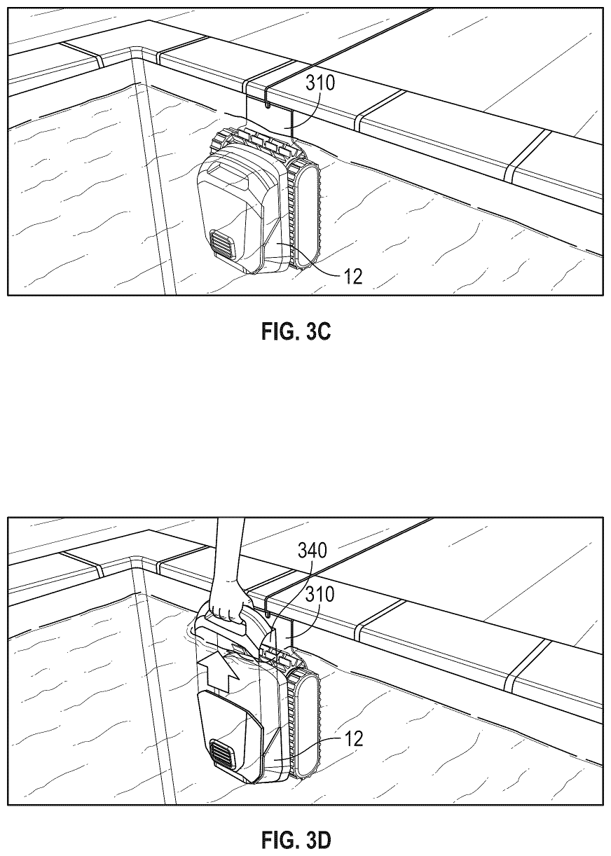

FIGS. 2A-C and 3A-D illustrate further examples of docking stations for inductively charging the APC 12. Compared to the docking station of FIGS. 1A-B, the docking stations of FIGS. 2A-C and 3A-D may be within water of the pool or spa, such as but not limited to in water and submerged, such as on a floor or a wall (FIGS. 2A-C) or in the water and at the waterline (FIGS. 3A-D). In certain embodiments, and as discussed in detail below, the docking stations in the water of the pool or spa may be utilized to inductively charge the APC 12 while the APC 12 is in water of a pool or spa.

In some embodiments, and as illustrated in FIGS. 2A-C, a docking station 210 may be provided within the water of a swimming pool 230, such as on a floor 232 of the swimming pool 130. In other embodiments, the docking station 210 may be provided on other submerged surfaces of the swimming pool 230, such as but not limited to a wall, a bench, a stair, a beach, and/or as otherwise desired. In some embodiments, the docking station 210 may be provided at a location within the water of the swimming pool 230 using various mechanisms or techniques as desired. As non-limiting examples, the docking station 210 may utilize features or mechanisms to locate the docking station 210 at a particular location, such as but not limited to mechanical fasteners, weights, suction members, adhesives, and/or as otherwise desired. In some embodiments, the docking station 210 may be fixed and/or permanently provided at a location within the swimming pool 230, while in other embodiments, the docking station 210 may be positionable at various locations within the pool as desired. Wiring 28 to the docking station 210 may be fixed and/or otherwise secured on one or more surfaces of the swimming pool 230; however, in other embodiments, the wiring 28 need not be secured and instead may be free-floating, movable, and/or otherwise not fixed while the docking station 230 is in the water.

As illustrated in FIG. 2A, in various embodiments, the docking station 210 may have one or more inductive elements 22. The docking station 210 in the water and on a floor, wall, and/or other submerged surface of the swimming pool 230 may allow for the APC 12 to charge itself as needed without requiring the APC 12 be removed from water of the swimming pool 230. In some embodiments, the docking station 210 omits the feet 18 of the docking station 10, although in other embodiments the docking station 210 may have one or more feet. Optionally, and as illustrated in FIG. 2A, the docking station 210 may includes one or more raised portions 233, such as but not limited to one or more ribs, ridges, bumpers, stoppers, etc., which may facilitate locating and positioning the APC 12 on the docking station 210. As a non-limiting example, the APC 12 optionally may engage the raised portion 233 when the APC 12 is on the docking station 210 and/or positioned such that the induction elements of the APC 12 are in position to be charged by the induction element 22 of the docking station 210. In other embodiments, the docking station 210 need not include the one or more raised portions 233, and/or the one or more raised portions 233 may be provided in other locations, arrangements, and/or patterns as desired.

As illustrated in FIGS. 2A-B, in some embodiments, the docking station 210 may include a communication module 234 for communicating with the APC 12. Optionally, the communication module 234 may be provided on the one or more raised portions 233, although it need not be in other embodiments and instead may be at other locations on the docking station 210 as desired. In certain embodiments, the communication between the docking station and the APC 12 may be used by the APC 12 to perform various operations, such as but not limited to guiding the APC 12 to the docking station 210, allowing the APC 12 to locate the docking station 210 within the swimming pool 230, and/or otherwise controlling of the APC 12.

In various embodiments, the communication module 234 provides wireless communication when the APC 12 is submerged in a pool or other body of water. Optionally, the communication module 234 may enable communication between the docking station 210 and the APC 12 when the APC 12 and/or the docking station 210 is not submerged. In some embodiments, the wireless communication may be bi-directional, although in other embodiments the wireless communication may be unidirectional. As non-limiting examples, the docking station 210 may emit and/or provide a wireless communication that is received by the APC 12, the APC 12 may emit and/or provide a wireless communication that is received by the docking station 210, or both.

Various types of wireless communications may be utilized by the communication module 234. As one non-limiting example, the wireless communication may be light-based signals, including but not limited to light fidelity (LiFi) signals, may be utilized by the docking station 210 to communicate with the APC 12 and/or vice versa. In some embodiments, characteristics of the light signals may be used to control the APC 12. As non-limiting examples, a pattern of light, a light color, a light brightness, a frequency, combinations thereof, or other characteristics or combinations of characteristics as desired may control the APC 12 and/or be utilized by the APC 12. As non-limiting examples, based on the light signals from the communication module 234, the APC 12 may navigate itself within the swimming pool 230, locate the docking station 230 within the swimming pool 230, stop movement, change a speed of movement, change direction of linear or rotational movement, position itself on the docking station 230, align itself on the docking station 230, stop a cleaning cycle, etc. Additionally, or alternatively, the wireless communication may include acoustic or sound signals, including but not limited to sound navigation and ranging (SONAR) or other types of signals. In additional or alternative embodiments, the wireless communication may be visual-based (e.g., utilizing one or more cameras on the APC 12, one or more cameras on the docking station 230, and/or at other locations or combinations of locations as desired). As a non-limiting example of such embodiments, one or more camera on the APC 12 may target and/or identify a specific mark, feature, or other guiding feature on the docking station 230 (which may be static or adjustable/changing). In some embodiments, visual and/or camera-based communication may be unidirectional, although in other embodiments such communication may be bi-directional. Other types of wireless communication may be utilized as desired.

In the embodiment illustrated, the communication module 234 is a LiFi communication module for light-based communication 211. In certain embodiments, the docking station 210 may at least utilize the communication module 234 with light-based communication to guide the APC 12 onto the docking station 210, to position and/or orient the APC 12 on the docking station 210, and/or to position the APC 12 relative to the one or more inductive elements 22 for charging of the APC 12.

FIGS. 3A-D illustrate another example of a docking station 310 that is similar to the docking station 210 except that the docking station 310 is provided at a waterline 342 of the swimming pool 230. Compared to the submerged docking station 210, the docking station 310 allows for inductive charging of the APC 12 while the APC 12 is at the waterline 342, which may facilitate access to the APC 12 by a user. In some embodiments, and as illustrated in FIG. 3D, the docking station 310 optionally may support the APC 12 such that a filter 340 of the APC 12 is easily accessible and removable from the APC 12 without completely removing the APC 12 from the swimming pool 130 (e.g., the APC 12 may be positioned on the docking station 310 such that the filter 340 is at or above the waterline 342). In these embodiments, the docking station 310 may be provided on a wall 336 of the swimming pool 230 at the waterline 342. Additionally, or alternatively, the docking station 310 may be provided at a skimmer 338 of the swimming pool 130.

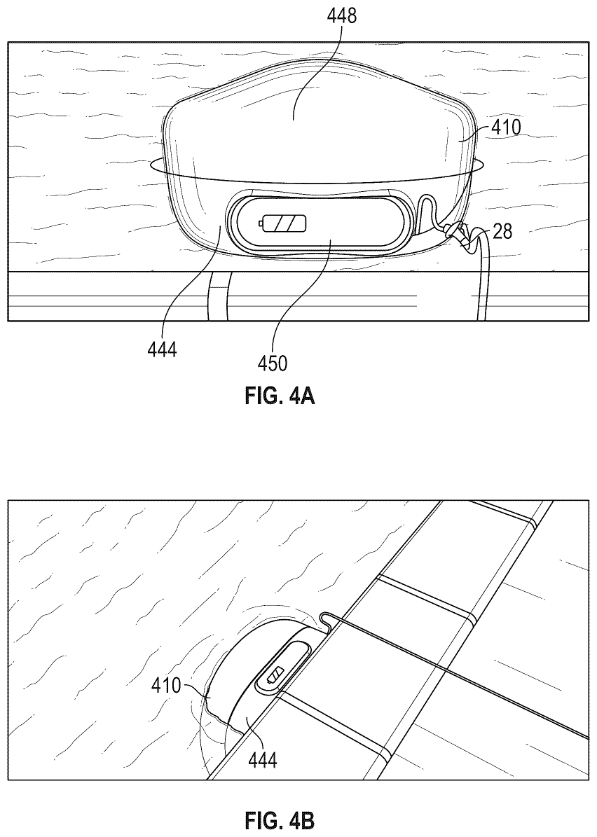

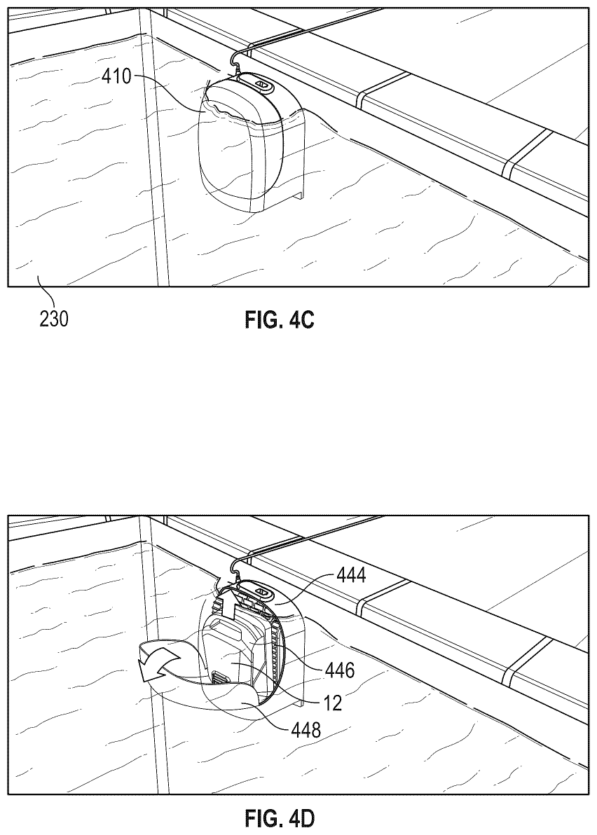

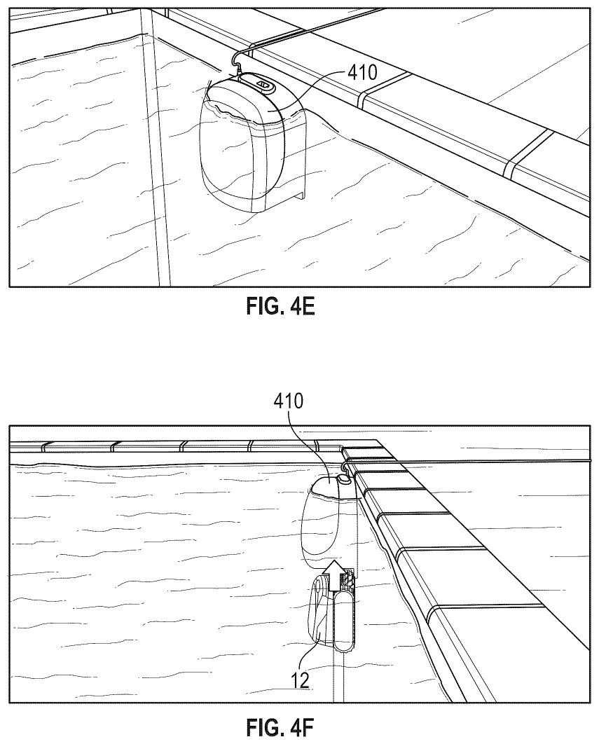

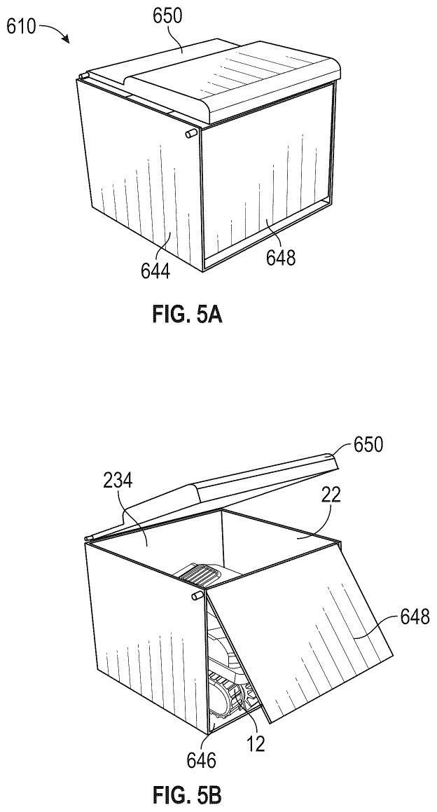

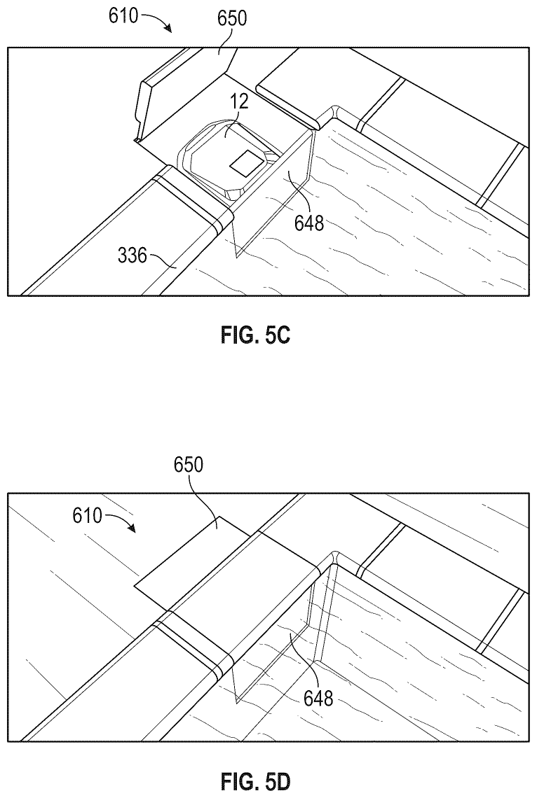

The docking stations of FIGS. 1A-B, 2A-C, and 3A-D may be considered “open” docking stations in that may engage and/or support the APC 12 without concealing and/or enclosing the APC 12. In other embodiments, and as illustrated in FIGS. 4A-F, 5A-D, and 6, docking stations for an APC 12 may conceal and/or enclose the APC 12 when the APC 12 is engaged with the docking station (e.g., during charging, while not in use, etc.). In these embodiments, the docking stations may use inductive charging, although other charging techniques or mechanisms may be utilized. In FIGS. 4A-F, 5A-D, and 6, the docking stations are provided at the waterline 342 of the pool 230, although the docking stations may be provided at other locations in and/or out of the pool 230 as desired, such as submerged within the pool 230, on a pool pad and/or otherwise outside of the pool 230, and/or as otherwise desired. In some embodiments, and as illustrated in FIGS. 4A-F, a docking station 410 may be provided as a separate component to the pool 230. As an example, in FIG. 4, the docking station 410 is supported on the wall 336 of the pool 230, and the docking station 410 may protrude from the wall 336. In other embodiments, a docking station 610 may be integrated with the pool 230 (see FIGS. 5A-D and 6).

Referring to FIGS. 4A-F, in some embodiments, the docking station 410 includes a housing 444, which defines a receiving area 446 (see FIG. 4D) for receiving the APC 12 when not in use, during charging, and/or as otherwise desired. The receiving area 446 may be selectively accessed as desired. Optionally, the receiving area 446 may be accessed in at least one direction (e.g., by opening a cover 448), and optionally, the receiving area 446 may be accessed in two directions and/or other directions as desired. As non-limiting examples, in certain embodiments, the cover 448 is movably attached to the housing 444—in a closed configuration of the cover 448 (FIGS. 4A-C), the APC 12 may be selectively enclosed or retained within the receiving area 446, and in an open configuration (FIG. 4D), the receiving area 446 is no longer enclosed, and APC 12 may be accessed and/or removed from the receiving area 446. Optionally, a nominal lower end 449 of the docking station 410 may define an opening which the APC 12 may drive through and into the receiving area 446 while the cover 448 is closed (FIG. 4F). In these embodiments, the opening in the lower end 449 optionally includes a cover, cover, door, and/or other device or mechanism for selectively preventing or allowing access through the opening. In embodiments with the opening in the lower end 449, the APC 12 may dock itself with the docking station 410 (through the opening) without requiring input from a user, and the cover 448 may provide additional access to the receiving area 446 for user as desired. In various embodiments, the APC 12 may be self-docking with the docking station 410 (e.g., as described above), and a user and/or supplemental devices or features may not be required to position the APC 12 within the receiving area 446. However, in other embodiments, the APC 12 need not be self-docking.

In certain embodiments, the docking station 410 includes features for charging the APC 12 while the APC 12 is retained within the receiving area 446. In one non-limiting example, the docking station 410 includes one or more inductive elements for charging the APC 12 while the APC 12 is within the receiving area 446.

In certain embodiments, the docking station 410 may include one or more sensors or cameras for measuring characteristics of the pool 230. Such sensors may include, but are not limited to, optical sensors, oxidation-reduction potential (ORP) sensors, pH sensors, water temperature sensors, salinity sensors, combinations thereof, and/or other sensors as desired.

Optionally, the docking station 410 includes a user interface, such as but not limited to a display 450, for displaying and/or providing various information to a user and/or for receiving information from the user. Such information may be information from the one or more sensors about the water of the pool 230, information about the APC 12 (e.g., charge level, time until fully charged, etc.), instructions to the APC 12, combinations thereof, and/or other information as desired. In the embodiment illustrated, the display 450 is provided on a portion of the housing 444 above the waterline 342, although in other embodiments, the display 450 and/or other user interface may be provided at other locations as desired.

As mentioned, the docking station 410 may hide or conceal the APC 12 when the APC is not in use, charging, and/or otherwise docked with the docking station 410 within the receiving area 446. In certain embodiments, an exterior surface of the housing 444 and/or the cover 448 may have a surface feature or finish for controlling the visual appearance of the docking station 410. In one non-limiting example, an exterior surface of the housing 444 and/or the cover 448 may have a highly reflective or mirror finish.

FIGS. 5A-D and 6 illustrate another example of a docking station 610 for concealing and/or enclosing the APC 12 when the APC 12 is not in use, charging, and/or otherwise docked with the docking station 610. Compared to the docking station 410, which is a separate component supported on or within the pool 230, the docking station 610 is integrated with the pool 230. Optionally, and as illustrated in FIGS. 5C-D, for example, the docking station 410 may be built into the pool 410 and/or otherwise integrated as desired. As a non-limiting example and as illustrated in FIG. 5C, a housing 644 of the docking station 610 defining a receiving area 646 may be recessed relative to the wall 336 of the pool 230.

In various embodiments, similar to the docking station 410, the receiving area 646 may be accessed in at least one direction, optionally in at least two directions and/or more than one direction as desired. In some embodiments, similar to the docking station 410, the docking station 610 may include a cover 648, which may provide access to a receiving area 646 of the housing 644 from a first direction (e.g., from inside the pool 230). Similar to the cover 448, the cover 648 may be movably attached to the housing 644 and may have a closed configuration (FIG. 5A), in which the APC 12 may be selectively enclosed or retained within the receiving area 646, and an open configuration (FIG. 5B), in which the receiving area 646 is no longer enclosed, and APC 12 may be accessed and/or removed from the receiving area 646.

Optionally, similar to the docking station 410, the docking station 610 may provide access to the receiving area 646 in a second direction. In the embodiment illustrated in FIGS. 5A-D, the docking station 610 includes a supplemental cover 652, which may be movably connected to the housing 644 and may provide access to the receiving area 646 from a second direction different from the first direction. Optionally, the supplemental cover 652 may allow a user to access the APC 12 within the receiving area 646 while the user is outside the pool 230.

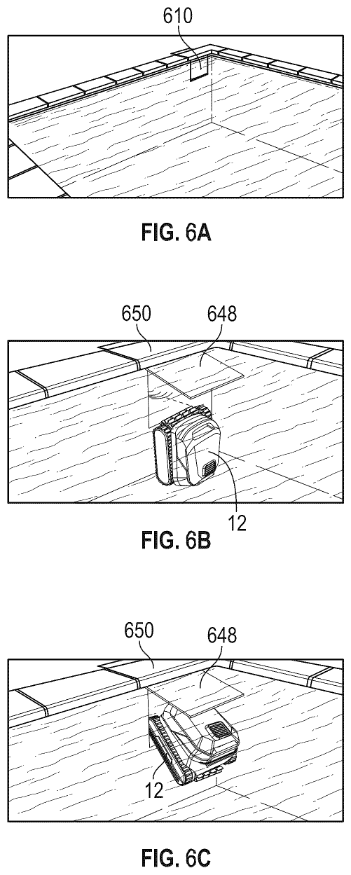

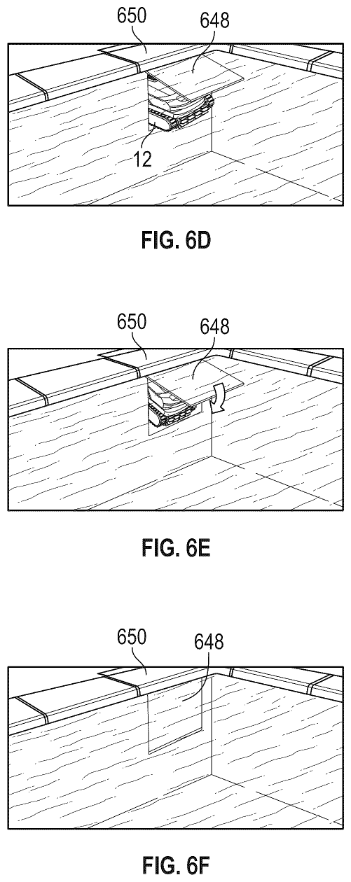

In various embodiments, and as illustrated in FIGS. 6A-F, the APC 12 may be self-docking with the docking station 610, and a user and/or supplemental devices or features may not be required to position the APC 12 within the receiving area 646. In such embodiments, the APC 12 may locate and/or otherwise be directed to the docking station 610 using the communication module 224, such as but not limited to a LiFi emitter. In certain embodiments, the cover 648 optionally may be automatically controlled to be in the open position or the closed position. As non-limiting examples, the position of the cover 648 may be controlled based on a location of the APC 12 relative to the docking station 610, a signal provided by the APC 12 to the docking station 610, a mechanical switch or button engaged by the APC 12, sensor data, communication from the communication module 224, and/or as otherwise desired. In certain embodiments, and as illustrated in FIGS. 6A-F, moving the cover 648 from the closed position to the open position allows for the APC 12 to climb into the receiving area 646. In certain embodiments, the cover 648 optionally may be automatically controlled to move from the open position to the closed position when the APC 12 is in the receiving area 646. Similar to movement from the closed position to the open position, the cover 648 may be controlled to move from the open position to the closed position based on the location of the APC 12, a signal provided by the APC 12, a mechanical switch or button, sensor data, a communication from the communication module 224, and/or as otherwise desired. While FIGS. 6A-F illustrate self-docking of the APC 12 with the docking station 610, in other embodiments, the APC 12 need not be self-docking.

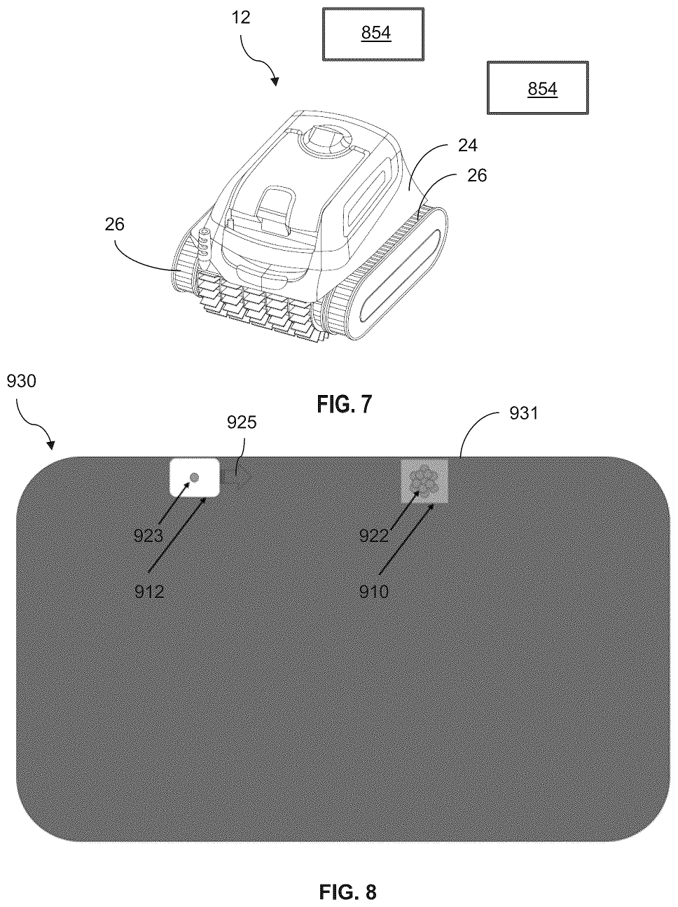

Referring to FIG. 7, in certain embodiments, a docking station need not inductively charge the entire APC 12. In such embodiments, a battery pack 854 or other power source of the APC 12 may be inductively charged when removed from the APC 12. As a non-limiting example, inductive charging of a battery pack 854 separate from the APC 12 may allow for a battery pack 854 to be provided on the APC 12 for powering the APC 12 while the other battery pack 854 is inductively charged. In these embodiments, inductive charging of the battery pack 854 separate from the APC 12 may allow the APC 12 to utilize more than one battery pack and extend usage of the APC 12.

Referring to FIG. 8, in some embodiments, a docking station 910 may be placed or located within a swimming pool 930 in close proximity to a wall 931 of the swimming pool 930. In some embodiments, the docking station 910 may include a plurality of transmitters 922 (e.g., inductive elements). Optionally, an APC 912, which may be similar to the APC 12, may include a receiver 923 (e.g., inductive element). The docking station 910 with the plurality of transmitters 922 may provide a larger area for induction charging and/or communication, thereby improving charging and/or communication capabilities as the docking station 910 does not have a single transmitter 922 that the receiver 923 must align with for effective charging and/or communication. In certain embodiments, as the APC 912 moves (represented by arrow 925) along the wall 931, the APC may identify (optionally without any additional sensor) that the receiver 923 has been energized by the transmitters 922. In some embodiments, responsive to identifying that the receiver 923 has been energized by the transmitters 922, the APC 912 may stop moving along the wall 931 if battery charging is required. The docking station 910 with the plurality of transmitters 922 may further provide improved guidance and positioning of the APC 912 relative to the docking station 910.

Exemplary concepts or combinations of features of the invention may include:
A. A docking station for supporting an APC out of water of a swimming pool or spa, the docking station comprising a platform extending upwards at a non-zero angle relative to a horizontal axis and at least one inductive element on the platform for charging the APC.
B. A docking station for an APC, the docking station positionable within water and on a floor of a swimming pool or spa, the docking station comprising at least one inductive element for charging the APC, wherein the docking station is configured to guide the APC to the docking station using light-based communications.
C. A docking station for an APC, the docking station comprising at least one inductive element for charging the APC, the docking station configured to guide the APC to the docking station using light-based communications.
D. A docking station for an APC, the docking station configured to engage the APC at a waterline of a swimming pool or spa, the docking station comprising at least one inductive element for charging the APC.
E. The docking station according to any preceding or subsequent statement or combination of statements, wherein the docking station is at a skimmer of the swimming pool or spa.
F. A docking station for an APC, the docking station configured to support the APC at a waterline of a swimming pool or spa, the docking station comprising at least one inductive element for charging the APC.
G. A docking station for an APC, the docking station configured to support the APC and provide access to a filter of the APC at a waterline of a swimming pool or spa, the docking station comprising at least one inductive element for charging the APC.
H. The docking station according to any preceding or subsequent statement or combination of statements, wherein the APC is positioned so the filter is at or above the waterline.
I. A docking station for an APC, the docking station comprising a housing defining a receiving area for housing the APC, wherein the docking station comprises at least one inductive element for charging the APC within the receiving area.
J. A docking station for an APC, the docking station comprising a housing configured to receive and conceal an APC, the docking station comprising at least one inductive charging element for charging the APC.
K. A docking station for an APC, the docking station configured to enclose the APC within a receiving area.
L. The docking station according to any preceding or subsequent statement or combination of statements, wherein the docking station is integrated into a swimming pool or spa.
M. The docking station according to any preceding or subsequent statement or combination of statements, wherein the docking station is supported on a wall of a swimming pool or spa.
N. The docking station according to any preceding or subsequent statement or combination of statements, wherein the docking station is at least partially submerged below a waterline of the swimming pool or spa.
O. The docking station according to any preceding or subsequent statement or combination of statements, further comprising a cover that is movable relative to the housing.
P. The docking station according to any preceding or subsequent statement or combination of statements, wherein at least a portion of an external surface of the housing is mirrored.
Q. An APC configured to dock with the docking station according to any preceding or subsequent statement or combination of statements, the APC comprising at least one inductive element.
R. The APC according to any preceding or subsequent statement or combination of statements, further comprising: a communication module configured to receive a light signal while the APC is at least partially submerged; and a controller configured to control the APC based on the received light signal.
S. An APC comprising one or more batteries, wherein the one or more batteries are chargeable or rechargeable via induction charging.
T. The APC according to any preceding or subsequent statement or combination of statements, wherein the one or more batteries are removable from the APC and chargeable or rechargeable independent of the APC.
U. A method comprising charging or recharging an onboard power source of an APC using any of the docking stations according to any preceding or subsequent statement or combination of statements.
V. A method comprising guiding an APC to a docking station using light-based communication and inductively charging the APC at the docking station.
W. A method comprising receiving an APC at a docking station and enclosing the APC within a receiving area of the docking station.
X. The method according to any preceding or subsequent statement or combination of statements, wherein the APC is cordless.
Y. The method according to any preceding or subsequent statement or combination of statements, further comprising causing the APC to position itself within the receiving area without assistance from another device.
Z. A docking station for an APC, wherein the docking station and the APC each comprise a plurality of inductive elements for charging the APC when the APC is in one or more configurations or positions relative to the docking station.
AA. A docking station for a pool cleaner comprises at least one inductive element for charging the pool cleaner and means for guiding the pool cleaner to the docking station using light-based communication.
BB. The docking station according to any preceding or subsequent statement or combination of statements, wherein the docking station comprises a platform extending upwards at a non-zero angle relative to a horizontal axis, and wherein the at least one inductive element is on the platform.
CC. The docking station according to any preceding or subsequent statement or combination of statements, wherein the docking station is positionable within water and on a floor of a swimming pool or spa.
DD. The docking station according to any preceding or subsequent statement or combination of statements, wherein the docking station is configured to engage the pool cleaner at a waterline of a swimming pool or spa.
EE. The docking station according to any preceding or subsequent statement or combination of statements, wherein the docking station further comprises a housing defining a receiving area for housing the pool cleaner.
FF. The docking station according to any preceding or subsequent statement or combination of statements, wherein the docking station is configured to support the pool cleaner and provide access to a filter of the pool cleaner at or above the waterline.
GG. The docking station according to any preceding or subsequent statement or combination of statements, wherein the docking station further a housing defining a receiving area for receiving and concealing the APC.
HH. The docking station according to any preceding or subsequent statement or combination of statements, further comprising means for guiding the pool cleaner to the docking station using light-based communication.
A. The docking station according to any preceding or subsequent statement or combination of statements, further comprising a first cover and a second cover, wherein the first cover controls access to the receiving area from a first direction and the second cover controls access to the receiving area from a second direction.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pools and spas, persons skilled in the relevant field will recognize that the present invention conceivably could be employed in connection with other objects and in other manners. Finally, references to “pools” and “swimming pools” herein may also refer to spas or other water containing vessels used for recreation or therapy and for which cleaning of debris is needed or desired.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A docking station for a pool cleaner comprises at least one inductive element for charging the pool cleaner and means for guiding the pool cleaner to the docking station using light-based communication.

2. The docking station of claim 1, wherein the docking station comprises a platform extending upwards at a non-zero angle relative to a horizontal axis, and wherein the at least one inductive element is on the platform.

3. The docking station of claim 1, wherein the docking station is positionable within water and on a floor of a swimming pool or spa.

4. The docking station of claim 1, wherein the docking station is configured to engage the pool cleaner at a waterline of a swimming pool or spa.

5. The docking station of claim 4, wherein the docking station is at a skimmer of the swimming pool or spa.

6. The docking station of claim 1, wherein the docking station further comprises a housing defining a receiving area for housing the pool cleaner.

7. A docking station for a pool cleaner comprises means for engaging and/or supporting the pool cleaner at a waterline of a swimming pool or spa and at least one inductive element for charging the pool cleaner.

8. The docking station of claim 7, wherein the docking station is configured to support the pool cleaner and provide access to a filter of the pool cleaner at or above the waterline.

9. The docking station of claim 7, wherein the docking station is configured to support the pool cleaner such that a filter of the pool cleaner is at or above the waterline.

10. The docking station of claim 7, wherein the docking station further a housing defining a receiving area for receiving and concealing the APC.

11. The docking station of claim 10, wherein the at least one inductive element is within the receiving area.

12. The docking station of claim 7, further comprising means for guiding the pool cleaner to the docking station using light-based communication.

13. The docking station of claim 7, wherein the docking station is integrated into the swimming pool or spa.

14. The docking station of claim 7, wherein the docking station is supported on a wall of the swimming pool or spa.

15. A docking station for a pool cleaner comprises a receiving area, wherein the docking station is configured to enclose the pool cleaner within the receiving area.

16. The docking station of claim 15, wherein the docking station is integrated into a swimming pool or spa or is supported on a wall of a swimming pool or spa.

17. The docking station of claim 15, wherein the docking station is at least partially submerged below a waterline of the swimming pool or spa.

18. The docking station of claim 15, further comprising a cover that is movable relative to the housing.

19. The docking station of claim 15, further comprising a first cover and a second cover, wherein the first cover controls access to the receiving area from a first direction and the second cover controls access to the receiving area from a second direction.

20. The docking station of claim 15, wherein at least a portion of an external surface of the housing is mirrored.
